(19) United States
(12) Patent Application Publication
(10) Pub. No.: US 2004/0053013 A1
(43) Pub. Date: Mar. 18, 2004

(54) Resin composition for forming sheets for ink printing and sheet for ink printing

(75) Inventors: Osamu Kyono, Ichihara-shi (JP); Takeshi Yamada, Tsukuba (JP)

Correspondence Address: SUGHRUE MION, PLLC, 2100 PENNSYLVANIA AVENUE, N.W., SUITE 800, WASHINGTON, DC, 20037, US

(73) Assignee: SUMIKA PLASTECH CO., LTD.

(21) Appl. No.: 10/602,825

(22) Filed: Jun. 25, 2003

(30) Foreign Application Priority Data
Jun. 27, 2002 (JP) 2002-187929
Mar. 5, 2003 (JP) 2003-058131

(51) Int. Cl. B32B 3/00

(52) U.S. Cl. 428/195.1

(57) ABSTRACT

Disclosed is a resin composition for forming sheets for ink printing comprising from 30 to 90% by weight of an ink-absorbent resin (A) and from 70 to 10% by weight of an ink-unabsorbent resin (B) When ink is printed on a sheet for prepared from the resin composition, a high-quality printed material can be obtained while effectively preventing the ink from blotting and the sheet from cockling.

### BACKGROUND OF THE INVENTION

1. Field of the Invention

The present invention relates to a resin composition for forming sheets for ink printing and to a sheet for ink printing having an ink receiving layer formed of the resin composition.

2. Description of the Related Art

Liquid ink-jet ink to he used in ink-jet printers can be classified roughly into aqueous ink and nonaqueous ink (oil base ink) based on whether a solvent contained is water or not. The nonaqueous ink can be classified further into quick-drying solvent ink, slow-drying solvent ink and high-boiling hydrocarbon ink. On the other hand, liquid ink-jet ink can alternatively be classified, based on the mechanism of fixing of ink, into ink containing a solvent which infiltrate in a printing sheet and ink containing a solvent which vaporizes without infiltrating. Examples of ink which corresponds to the former type include aqueous ink, high-boiling hydrocarbon ink and slow-drying solvent ink, whereas examples which correspond to the latter type include quick-drying solvent ink.

As a sheet for ink printing on which print is applied using an ink containing a solvent which infiltrates a printing sheet, JP-A-10-250218, for example, discloses a sheet for ink printing obtained by applying a solution of a polymer soluble in a solvent for ink onto a support and then drying.

However, when such a sheet for ink printing is subjected to printing with an ink-jet printer, the ink applied infiltrates the ink receiving layer of the sheet to cause blotting of print images. Alternatively, the ink receiving layer is swollen with the ink and the sheet deforms or cockles.

### SUMMARY OF THE INVENTION

In view of the problems with such conventional sheets for ink printing, an object of the present invention is to provide a resin composition for forming sheets for ink printing, the resin composition being capable of forming an ink receiving layer which has good ink absorbability and causes no blotting or cockling when being applied with print by use of an ink-jet printer. Another object of the present invention is to provide a sheet for ink printing which has good ink absorbability and causes no blotting or cockling.

In an aspect of the present invention, provided is a resin composition for forming sheets for ink printing comprising from 30 to 90% by weight of an ink-absorbent resin (A) and from 70 to 10% by weight of an ink-unabsorbent resin (B).

In another aspect of the present invention, provided is a sheet for ink printing having an ink receiving layer formed of the above-mentioned resin composition.

### DESCRIPTION OF THE PREFERRED EMBODIMENTS

The ink-absorbent resin (A) and the ink-unabsorbent resin (B) used in the present invention are, respectively, defined as follows.

Using a subject resin and employing a known sheeting technique such as extrusion forming, a sheet composed of the resin is produced. The method for producing the sheet is not particularly restricted and any method which can produce a sheet having a thickness of 20 μm or more and a ten point height of irregularities (Rz) of 5 μm or less may be applied. The measurement of Rz is carried out according to JIS B-0601. Using the sheet as a test sample and employing an ink for use, an amount of ink transfer is determined by Bristow's method provided in J. TAPPI, Test of Paper and Pulp, No. 51-87 “Liquid Absorption Test Method for Paper and Paperboard (Bristow's method) (1987)”.

In the present invention, a resin with an amount of ink transfer of 25 ml/m² or more as determined in the above-mentioned procedure at an absorption time of 20,000 ms is defined as ink-absorbent resin (A). On the other hand, a resin which has an amount of ink transfer of less than 25 ml/m² is defined as ink-unabsorbent resin (B).

In the case where it is difficult to prepare a single-layer sheet of a resin for test, the determination of the amount of ink transfer is carried out by Bristow's method using a laminate sheet comprising a support made of a material other than the resin and a layer of the resin having a thickness of 20 μm or more. The method for producing the laminate sheet is not particularly restricted and may be, for example, multilayer extrusion.

When a resin composition comprising an ink-absorbent resin (A) having an amount of ink transfer of 25 ml/m² or more as determined in the above-mentioned procedure and an ink-unabsorbent resin (B) having an amount of ink transfer of less than 25 ml/m² is used for forming an ink receiving layer, a resulting sheet for ink printing having the ink receiving layer has good ink absorbability and is capable of inhibiting blotting of ink. In view of ink absorbability and inhibition of ink blotting, the ink-absorbent resin (A) used in the present invention preferably has an amount of ink transfer of 30 ml/m² or more and the ink-unabsorbent resin (B) preferably has an amount of ink transfer of not more than 20 ml/m². Moreover, in view of inhibition of ink blotting, the difference between the amount of ink transfer of the ink-absorbent resin (A) and that of the ink unabsrobent resin (B) is preferably 20 ml/m² or more.

Ink is constituted of a solvent, which is a main ingredient, and pigment or dye. The ink absorbability used in the present invention, therefore, actually denotes the absorbability of a solvent for ink. Hereinafter, the term “ink absorbability” is used in the same meaning as “solvent absorbability”.

As a solvent for ink, usually employed are aliphatic hydrocarbons, aromatic hydrocarbons, ketones such as acetone and methyl ethyl ketone, esters such as ethyl acetate and butyl acetate, ethylene glycol monoethers such as ethylene glycol monobutyl ether and ethylene glycol monoethyl ether, ethylene glycol monoether acetates such as ethylene glycol methyl ether acetate, ethylene glycol ethyl ether acetate and ethylene glycol monobutyl ether acetate, etc.

At present, ethylene glycol monoether acetate is used in many occasions as a solvent of a nonaqueous ink-jet ink. Examples of a resin (A) which absorbs ethylene glycol monoether acetate include acrylic resin softened by addition of rubber components.

The ink-absorbent resin (A) is preferably amorphous resin or resin having an SP value of at least 8.5.

The amorphous resin is. a resin in which an orderly structure exists locally. The amorphous resin does not show in an X-ray diffraction pattern any sharp peak caused by crystals. When such a resin is used as ink-absorbent resin (A), a printing sheet can be obtained which achieves rapid absorption of ink and is of good quick-drying property.

Examples of the amorphous resin include cyclic polyolefin and butadiene.

An SP value is obtained as a square root of a cohesive energy density and is called a solubility parameter, etc. When a resin having an SP value of 8.5 or more is used as the ink-absorbent resin (A), ink is easily dissolved in the resin and, therefore, a printing sheet capable of absorbing a large amount of ink can be provided.

Examples of resins having an SP value of at least 8.5 include polymethyl methacrylate.

In view of quick-drying property and ink absorbability, the ink-absorbent resin (A) in the present invention is more preferably an amorphous resin having an SP value of at least 8.5. Examples of such resin include styrene-based resins having an aromatic vinyl compound as a repeating unit such as polystyrene, rubber-modified polystyrene, poly(α-methyl styrene), poly(p-methyl styrene) and ethylene-styrene random copolymer, polycarbonate, poly(vinyl chloride) and ABS resin. It is more preferable that styrene-based resin be used.

When an ink solvent is ethylene glycol monoether acetate, examples of the ink-unabsorbent resin (B) include polyethylenes such as high density polyethylene, low density polyethylene, linear low density polyethylene and linear ultra low density polyethylene, polypropylenes such as homopolypropylene, block copolymerized polypropylene and random copolymerized polypropylene, olefin-based resins such as ethylene-propylene copolymer, ionomer resin, ethylene-vinyl acetate copolymer having a vinyl acetate unit content less 40% by weight, ethylene-acrylic acid copolymer having an acrylic acid unit content less 40% by weight, ethylene-methacrylic acid copolymer having a methacrylic acid unit content less 40% by weight, ethylene-methyl methacrylate copolymer having a methyl methacrylate unit content less 40% by weight and modified polyolefin, e.g. reaction products from homo- or copolymer of olefin and unsaturated carboxylic acid, such as maleic acid and fumaric acid, or its anhydride, polyamide resin such as 6-Nylon and 6,6-Nylon, fluororesin such as trifluorochloroethylene resin, tetrafluoroethylene resin and fluorovinylidene resin, and polyacetal resin.

In view of inhibition of ink blotting, the ink-unabsorbent resin (B) is preferably an olefin-based resin and more preferably is polyethylene or polypropylene.

In the present invention, a judgment on whether a resin is an ink-absorbent resin (A) or an ink-unabsorbent resin (B) is made based on a result obtained through the aforementioned measurement using an ink actually used for printing. Therefore, a certain resin may be judged as being an ink-absorbent resin (A) or alternatively an ink-unabsorbent resin (B) depending on the type of the ink to be used.

In view of ink absorbability and inhibition of ink blotting, the resin composition for forming sheets for ink printing according to the present invention is a resin composition comprising from 30 to 90% by weight of the ink-absorbent resin (A) and from 70 to 10% by weight of the ink-unabsorbent resin (B) and preferably is a resin composition comprising from 40 to 70% by weight of the ink-absorbent resin (A) and from 60 to 30% by weight of the ink-unabsorbent resin (B)

The resin composition of the present invention may contain other ingredients such as additives unless the desired effect of the invention is impaired.

Examples of such additives include antioxidants, ultraviolet. absorbers, light stabilizers, colorants such as pigment, compatibilizers, antistatic agents and flame retardants.

Two or more resins may be used in combination as ink-absorbent resin (A) Moreover, two or more resins may be used in combination as ink-unabsorbent resin (B). When two or more resins are used in combination, a combined amount of the resins judged as being the ink-absorbent resin (A) as a result of the measurement of amount of ink transfer for each resin is set from 30 to 90% by weight in a resulting resin composition and a combined amount of the resins judged as being the ink-unabsorbent resin (B) is set from 70 to 10% by weight in the resulting resin composition.

A method for producing the resin composition of the present invention is not particularly restricted. For example, the resin composition can be produced by combining ink-absorbent resin (A), ink-unabsorbent resin (B) and, as required, additives such as stabilizers, lubricants, antiblocking agents and pigments, and mixing and/or kneading the mixture using a mixer or kneader usually employed such as a ribbon blender, a super mixer, a Banbury mixer and a single or twin screw extruder.

The sheet for ink printing of the present invention has an ink receiving layer composed of the resin composition for forming sheets for ink printing described previously. The thickness of the ink receiving layer is preferably from 5 to 200 μm, and more preferably from 30 to 100 μm in view of ink absorbability.

The sheet for ink printing of the present invention may be a single layer sheet consisting of an ink receiving layer or, alternatively, a multilayer sheet which contains one or more layers other than the ink receiving layer, such as a support layer. In view of inhibition of cockling, the sheet for ink printing of the present invention preferably is a multilayer sheet having a support layer composed of an ink-unabsorbent resin layer (B).

The sheet for ink printing of the present invention preferably has a support layer. The material which constitutes the support layer is not particularly restricted. For example, the support layer is constituted of resin, fiber, metal, ceramic, etc. From a productivity standpoint, the support layer is preferably a resin sheet.

When the support layer is a resin sheet, it may contain additives such as antioxidants, ultraviolet absorbers, light stabilizers, colorants such as pigment, compatibilizers, antistatic agents and flame retardants. Especially, it is preferable that the layer contain a flame retardant. Examples of flame retardants available include inorganic flame retardants such as aluminum hydroxide and magnesium hydroxide, phosphorus-containing flame retardants, halogen-containing flame retardants and melamine type flame retardants. In particular, flame retardants known as NOR type HALS are suitably employed.

When the support layer is a resin sheet, it is preferable that the sheet contain a copolymer having a polar group such as ethylene-methyl methacrylate copolymers and ethylene-vinyl acetate copolymers so that the content of the polar group becomes approximately 10% by weight of the total amount of resin in view of high frequency welder processability. It is preferable to impart the high frequency welder processability to the support layer because it becomes possible to produce a sheet for wide printing by high frequency welder processing of printing sheets of the present invention.

The thickness of the support layer is not particularly limited, but it is preferably from 10 to 1,000 μm and more preferably from 40 to 500 μm from a viewpoint of converting workability.

When the sheet for ink printing of the present invention has an ink receiving layer and a support layer, forming of an adhesive layer between the layers can enhance the adhesiveness between the layers.

The method for producing the sheet for ink printing of the present invention is not particularly restricted. It can be produced, for example, by a conventional extrusion method applied for the production of sheets, such as T-die film forming and blown film extrusion, using therein a resin composition for forming sheets for ink printing obtained by the aforementioned method. Especially, preferred is a method of producing a sheet for printing by simultaneously extruding an ink receiving layer, a support layer and an adhesive layer by multilayer extrusion due to its good productivity. In particular, T-die casting is preferably employed because it is easy to carry out multilayer forming by use of the technique. Moreover, when producing a wide printing sheet having a width of 5 m or more, it is preferable to produce it by blown film extrusion in which the extrusion width can be changed easily.

It is preferable that in the sheet for ink printing of the present invention, an ink receiving layer, a support layer, a pressure sensitive adhesive layer and a release paper sheet be disposed in this order. The release paper sheet and a pressure sensitive adhesive for forming the pressure sensitive adhesive layer are not particular restricted, Pressure sensitive adhesives widely known may be employed, for example, acrylic type pressure sensitive adhesive, vinyl ether type pressure sensitive adhesive and rubber type pressure sensitive adhesive. As the release paper sheet, ones comprising a paper sheet coated with a releasing agent are usually employed. However, films of resin such as polyethylene terephthalate may be used in place of paper.

For laminating the pressure sensitive adhesive layer to the support layer, known methods can be applied. For example, roll coating such as direct gravure coating, reverse gravure coating, two-roll beat coating and bottom feed three-roll reverse coating, doctor knife coating, die coating, bar coating, and a technique in which a pressure sensitive adhesive is applied by an appropriate combination of them. The release paper sheet is preferably laminated continuously after the lamination of the pressure sensitive adhesive layer. Alternatively, it is also possible to laminate the pressure sensitive adhesive layer and the releasing paper sheet by a transferring method. The transferring method is a method of laminating a pressure sensitive adhesive layer and a releasing paper sheet by piling and pressing the releasing paper sheet having on one side thereof the pressure sensitive adhesive layer onto a printing sheet having an ink receiving layer so that the pressure sensitive adhesive layer comes into contact with a surface of the printing sheet other than the ink receiving layer.

When laminating a pressure sensitive adhesive layer onto a support layer, it is preferable to treat a surface of the support layer in advance so that the surface comes to have a wet index of 35 dyne/cm or more. As the method for the surface treatment, known methods may be employed. For example, corona treatment, flame plasma treatment, ozone treatment, electron beam radiation treatment and anchor treatment are mentioned. Particularly preferred is corona discharge treatment. Moreover, it is also possible to use these techniques in combination.

The sheet for ink printing of the present invention preferably has a fibrous substrate layer. A sheet for ink printing containing the fibrous substrate layer has superior tensile strength and can be suitably used for large width applications and for outdoor applications.

As the fibrous substrate layer, available are cloth, knitted fabric, nonwoven fabric or the like prepared by pure or blended spinning or looming of natural fiber such as cotton, silk, hemp and wool, regenerated or semisynthetic fiber such as rayon and acetate, synthetic fiber such as polyester resin fiber, polyamide fiber such as Nylon-6 and Nylon-6,6, polyolefin fiber such as polypropylene and high density polyethylene, alumina fiber and carbon fiber.

A sheet for ink printing having an ink receiving layer and a fibrous substrate layer can be produced, for example, by a method in which a resin composition for a sheet for ink printing according to the present invention is laminated onto the fibrous substrate layer by extrusion lamination. When the sheet for ink printing is a sheet further having a support layer as well as the ink receiving layer and the fibrous substrate layer, it can be produced by a method comprising disposing the fibrous substrate layer between the ink receiving layer and the support layer and then pressure welding while heating, a method comprising applying an adhesive to the ink-receiving layer, the fibrous substrate layer and the support layer on their surfaces which are to come into contact with each other and then adhering the layers under pressure. A method combining the above-mentioned two methods may also be employed.

An ink-printing sheet having an ink receiving layer of the present invention on both sides of a fibrous substrate layer is a sheet capable of being printed on both sides thereof. This sheet is suitable as a double-sided printing sheet.

When ink is printed on a sheet for ink printing according to the present invention, which has been described previously, a high-quality printed material can be obtained while effectively preventing the ink from blotting and the sheet from cockling. Concretely speaking, the printing method is a method comprising applying ink to a sheet having an ink receiving layer wherein the ink receiving layer is formed of a resin composition comprising from 30 to 90% by weight of an ink-absorbent resin (A) and from 70 to 10% by weight of an ink-unabsorbent resin (B). It is noted that the sheet for use in this printing method may be in improved embodiments as those described previously. The mode of printing is not particularly restricted. For example, offset printing, gravure printing and ink-jet printing are applicable.

The resin composition for forming sheets for ink printing according to the present invention is a resin composition capable of forming an ink receiving layer which has good ink absorbability and causes no blotting or cockling. Moreover, a sheet for ink printing having an ink receiving layer composed of the resin composition is a sheet which has good ink absorbability and causes no blotting or cockling.

### EXAMPLES

The present invention is illustrated in detail below with reference to Examples, which do not limit the scope of the invention.

[Measurement of Amount of Ink Transfer]

From each resin used in Examples, a single-layer sheet having a thickness of 110 μm and an Rz of 3.2 μm was prepared by a T-die cast film forming technique.

Using an ink mainly comprising ethylene glycol mono-n-butyl ether acetate for a nonaqueous solvent-type ink-jet printer “Lamiless” manufactured by Mutoh Industries Ltd., an amount of ink transfer to each sheet at an absorption time of 20000 ms was determined by the Bristow method provided in J. TAPPI, Test of Paper and Pulp, No. 51-87 “Liquid Absorption Test Method for Paper and Paperboard (Bristow's method) (1987)”.

A resin having an amount of ink transfer of 25 ml/m² or more is considered to be ink-absorbent resin (A), whereas a resin having an amount of ink transfer less than 25 ml/m² is considered to be ink-unabsorbent resin (B).

### [Example 1]

75 parts by weight of a rubber-modified polystyrene (soft component particle content=20.8% by weight, melt flow rate=3.2 g/10 min, amorphous resin, SP value=9.0, amount of ink transfer=60 ml/m²) and 10 parts by weight of a hydrogenated styrene-isoprene block copolymer (styrene content=65% by weight, amorphous resin, SP value=8.8, amount of ink transfer=43 ml/m²) as ink-absorbent resin (A), and 20 parts by weight of a linear low density polyethylene (melt flow rate=0.8 g/10 min, density 0.925 gl/cm², amount of ink transfer=not more than 10 ml/m²) and 30 parts by weight of an ethylene-methyl methacrylate copolymer (methacrylate unit content=38% by weight, amount of ink transfer=20 ml/m²) were pellet blended. The pellet-blended material was kneaded and palletized with a co-rotating twin screw kneading extruder at an extrusion temperature of 200-220° C., producing a resin composition (1) for a sheet for ink printing.

A mixture of 90% by weight of the resin composition (1) and 10% by weight of a white pigment titanium oxide masterbatch was extruded through a T-die at an extrusion temperature of 230° C. to form a single-layer sheet for ink printing with a thickness of 110 μm.

### [Example 2]

In the same manner as Example 1, a pellet (2) was prepared which was composed of 80 parts by weight of a polystyrene (not modified with rubber, melt flow rate=3 g/10 min, amorphous resin, SP value=9.1, amount of ink transfer=49 ml/m²) and 7.5 parts by weight of a hydrogenated styrene-isoprene block copolymer of the same type as that used in Example 1 as ink-absorbent resin (A) and 20 parts by weight of a linear low density polyethylene (melt flow rate=1.7 g/10 min, density=0.925 g/cm³, amount of ink transfer=10 ml/m² or less) as ink-inabsorbabel resin (B).

Using the pellet (2) as a raw material of an ink receiving layer, and a mixture of 90% by weight of a linear low density polyethylene resin (melt flow rate=1.7 g/10 min, density=0.915 g/cm³ amount of ink transfer=10 ml/m² or less) and 10% by weight of a white pigment titanium oxide masterbatch as a raw material of a support layer, a sheet for ink printing made up of two layers, the ink receiving layer and the support layer, was prepared by coextrusion. The ink receiving layer and the support layer had thicknesses of 30 μm and 80 μm, respectively.

### [Example 3]

In the same manner as Example 1, a pellet (3) was prepared which was composed of 55 parts by weight of a rubber-modified polystyrene and 7.5 parts by weight of a hydrogenated styrene-isoprene block copolymer, both being of the same types of those used in Example 1, 15 parts by weight of a linear low density polyethylene of the same type as that used in Example 2 and 22.5 parts by weight of an ethylene-methacrylic acid copolymer (methacrylic acid unit content=31% by weight, crystalline resin, SP value=8.5, amount of ink transfer=20 ml/m² or less).

Using the pellet (3) as a raw material of an ink receiving layer, and a mixture of 90% by weight of a linear low density polyethylene resin (melt flow rate 1.7 g/10 min, density=0.915 g/cm³ amount of ink transfer=10 ml/m² or less) and 10% by weight of a white pigment titanium oxide masterbatch as a raw material of a support layer, a sheet for ink printing made up of two layers, the ink receiving layer and the support layer, was prepared by coextrusion. The ink receiving layer and the support layer had thicknesses of 30 μm and 150 μm, respectively.

### [Example 4]

In the same manner as Example 1, a pellet (4) was prepared which was composed of 55 parts by weight of rubber-modified polystyrene and 7.5 parts by weight of hydrogenated styrene-isoprene block copolymer, both being of the same types of those used in Example 1, and 31.5 parts by weight of ethylene-methacrylic acid copolymer of the same type as that used in Example 3.

Using the pellet (4) as a raw material of an ink receiving layer, and a mixture of 90% by weight of a linear low density polyethylene resin (melt flow rate=1.7 g/10 min, density=0.915 g/cm³ amount of ink transfer=10 ml/m² or less) and 10% by weight of a white pigment titanium oxide masterbatch as a raw material of a support layer, a sheet for ink printing made up of two layers, the ink receiving layer and the support layer, was prepared by coextrusion. The ink receiving layer and the support layer had thicknesses of 30 μm and 150 μm, respectively

### [Example 5]

The pellet (4) of Example 4 as a raw material of an ink receiving layer (a first layer) and a mixture of 90% by weight of polyethylene resin and 10% by weight of white pigment titanium oxide masterbatch as a raw material of a second layer were extrusion laminated to a high density polyethylene nonwoven fabric (basis weight=100 g/m²) from both sides thereof by use of an extrusion laminator (equipped with the two-layer coextrusion T-die cast device the same as that used in Example 1). The ink receiving layer (the first layer) and the second layer had thicknesses of 30 μm and 80 μm, respectively. The order of the layer structure is (first layer)/(second layer)/(nonwoven fabric)/(second layer)/(first layer). A fiber-reinforced sheet for ink printing with a total thickness of 300 μm was obtained.

### [Comparative Example 1]

Using a rubber-modified polystyrene of the same type as that used in Example 1 as a raw material of an ink receiving layer and a mixture of 90% by weight of a linear low density polyethylene resin (melt flow rate=1.7 g/10 min, density=0.915 g/cm³, amount of ink transfer=10 ml/m² or less) and 10% by weight of a white pigment titanium oxide masterbatch as a raw material of a support layer, a sheet for ink printing made up of two layers, the ink receiving layer and the support layer, was produced. The printing sheet was produced by two-layer coextrusion using the T-die casting machine used in Example 1 equipped with a single screw extruder. The ink receiving layer and the support layer had thicknesses of 30 μm and 80 μm, respectively.

### [Comparative Example 2]

A sheet for ink printing made up of two layers, an ink receiving layer and a support layer, was produced in the same manner as Comparative Example 1 except using an ethylene-methyl methacrylate copolymer (methacrylate unit content=18% by weight, amount of ink transfer=17 ml/m²) as a raw material of the ink receiving layer. The ink receiving layer and the support layer had thicknesses of 30 μm and 80 μm, respectively.

[Print test]

The following evaluations were conducted by applying print on each sheet for ink printing by use of a nonaqueous solvent type ink-jet printer, “Lamiless PJ-1304NX” (manufactured by Mutoh Industries Co,, Ltd., main solvent of ink=ethylene glycol mono-n-butyl ether).

(1) Ink Absorbability

Solid printing in black, cyan, magenta and yellow was conducted and in the printed portions ink absorbability and drying property were evaluated.

o: Immediately after the printing, no ink remains unabsorbed and a finger is not stained even when touching therewith .

Δ: Immediately after the printing, when touching with a finger, it gets some stain. However, the stain appears to cause no practical problems.

x: When touching with a finger immediately after the printing, the finger gets stain. Moreover, during the printing, a printed surface is disturbed due to the friction of the surface with an ink head or the like.

(2) Blotting

Characters with variation in size were printed in black, cyan, magenta and yellow and a degree of blotting in each printed portion was evaluated.

o: Even the smallest characters (2 mm×2 mm) can be read with no problem.

Δ: It is difficult, but is not impossible, to read the smallest characters (2 mm×2 mm).

x: It is impossible to read the smallest characters (2 mm×2 mm).

(3) Cockling

Solid printing in black, cyan, magenta and yellow was conducted and a degree of cockling in each printed portion was evaluated.

o: No deformation is recognized in the printed sheet.

Δ: Some deformation is recognized in the printed sheet, but the deformation appears to cause no practical problems.

x: there is great undulation in the printed sheet.

The results of the print tests are shown in Table 1.

TABLE 1

| | Ink | | |
|---|---|---|---|
| | absorbability | Blotting | Cockling |
| Example 1 | ∘ | Δ | Δ |
| Example 2 | ∘ | Δ | Δ |
| Ecample 3 | ∘ | ∘ | ∘ |
| Ekample 4 | ∘ | ∘ | ∘ |
| Example 5 | ∘ | ∘ | ∘ |
| Comparative | ∘ | x | x |
| Example 1 | | | |
| Comparative | x | x | ∘ |
| Example 2 | | | |

what is claimed is:

1. A resin composition for forming sheets for ink printing comprising from 30 to 90% by weight of an ink-absorbent resin (A) and from 70 to 10% by weight of an ink-unabsorbent resin (B).

2. The resin composition according to claim 1, wherein the ink-absorbent resin (A) is an amorphous resin.

3. The resin composition according to claim 1, wherein the ink-absorbent resin (A) has an SP value of at least 8.5.

4. The resin composition according to claim 1, wherein the ink-absorbent resin (A) is an amorphous resin having an SP value of at least 8.5.

5. The resin composition according to claim 4, wherein the ink-absorbent resin (A) is a styrene-based resin.

6. The resin composition according to any one of claims 1-5, wherein the ink-unabsorbent resin (B) is an olefin-based resin.

7. A sheet for ink printing having an ink receiving layer, wherein the ink receiving layer is a layer of the resin composition according to claim 1.

8. The sheet according to claim 7, the sheet comprising the ink receiving layer, a support layer, a pressure-sensitive adhesive layer and a release paper sheet disposed in this order.

9. The sheet according to claim 7, the sheet further comprising a fibrous substrate layer.
